(19) United States
(12) Patent Application Publication
(10) Pub. No.: US 2012/0069360 A1
(43) Pub. Date: Mar. 22, 2012

(54) IMAGE FORMING APPARATUS, A CONTROL METHOD AND A RECORDING MEDIUM

(75) Inventor: Nagatoshi KAWA, Kanagawa (JP)

(73) Assignee: RICOH COMPANY, LTD., Tokyo (JP)

(21) Appl. No.: 13/228,500

(22) Filed: Sep. 9, 2011

(30) Foreign Application Priority Data
Sep. 16, 2010 (JP) 2010-207963

(51) Int. Cl. G06F 15/00; B65H 39/00

(52) U.S. Cl. 358/1.9; 270/58.07

(57) ABSTRACT

The image forming apparatus includes an image forming part configured to form an image on a sheet; a post-processing part configured to process a sheet bundle, the sheet bundle including sheets on which images are formed by the image forming part; an image quality maintaining/adjusting part configured to maintain quality of the image formed by the image forming part; a sheet spacing changing part configured to increase a spacing between a final sheet of the sheet bundle and a next sheet; and an operation controlling part configured to activate the operation of the image quality maintaining/adjusting part such that an operation of the image quality maintaining/adjusting part is completed within the spacing increased by the sheet spacing changing part.

### FIELD

The present invention is related to an image forming apparatus, such as a digital copier, a facsimile, a digital Multiple function processing apparatus (a multiple function printer: MFP), etc., which includes a post-processing part configured to receive and process a sheet, such as a paper sheet, etc., on which an image is formed (also referred to as “printed”, hereinafter) by an image forming part of the image forming apparatus, a control method in the image forming apparatus, and a computer-readable recording medium on which a program to be executed by the computer to control the image forming apparatus.

### BACKGROUND

Recently, post-processing functions in the image forming apparatuses have become increasingly enhanced and improved, so that stapling, punching, ring-banding, bookbinding, etc., have become easily automated. However, there is a demand for increased productivity.

In a circumstance of a production market, such as in a copy center in a corporation which handles printing (image-forming) of manuals, proposals or the like, it is known that, in order to constantly maintain quality of the printed images (also referred to as “image quality”, hereinafter), various image quality maintaining/adjusting processes for a printing part (image forming part) are performed in the course of a series of printing processes.

However, in the image forming apparatus including a post-processing device (a post-processing part), productivity (throughput) of printing may be decreased, because the feeding of the subsequent sheets is delayed during the post-processing, such as stapling, punching, bookbinding, etc.

Further, during the image quality maintaining/adjusting processes of the printing part, it is necessary to stop the printing process for the time being.

Thus, there is a problem in that the productivity of printing may be doubly decreased because the printing stop operation for the post-processing and the printing stop operation for the image quality maintenance are performed separately.

Patent Document 1 discloses a configuration in which a setup (marking set up) of the image printing during the post-processing (set ejecting operation), and if the post-processing is completed when the setup is completed, printing is restarted.

[Patent Document 1] Japanese Laid-open Patent Publication No. 2007-033829

However, according to the configuration disclosed in Patent Document 1, if the time required for the setup is longer than the time required for the post-processing, restart of the printing is delayed until the setup is completed, resulting in the decreased productivity.

The present invention was made in consideration of the matter described above, and an object of the present invention is to enable the image forming apparatus to avoid the decrease in the productivity of the printing as much as possible even if it performs the post-processing and the image quality maintaining/adjusting process.

### SUMMARY

According to an aspect of the embodiment, an image forming apparatus is provided. The image forming apparatus includes an image forming part configured to form an image on a sheet; a post-processing part configured to process a sheet bundle, the sheet bundle including sheets on which images are formed by the image forming part; an image quality maintaining/adjusting part configured to maintain quality of the image formed by the image forming part; a sheet spacing changing part configured to increase a spacing between the final sheet of the sheet bundle and a next sheet; and an operation controlling part configured to activate the operation of the image quality maintaining/adjusting part such that the operation of the image quality maintaining/adjusting part is completed within the spacing increased by the sheet spacing changing part.

### BRIEF DESCRIPTION OF DRAWINGS

FIG. 1 is a drawing conceptually illustrating an example of a schematic network configuration of an image forming system including an image forming apparatus with a post-processing device according to an embodiment.

FIG. 2 is a drawing illustrating an example of a hardware configuration of a server device SV illustrated in FIG. 1.

FIG. 3 is a drawing illustrating an example of functions of the server device SV illustrated in FIG. 2.

FIG. 4 is a plane view of an example of an overall configuration of each of image forming apparatuses P1 through P3 illustrated in FIG. 1.

FIG. 5 is a block diagram illustrating an example of a configuration of a control system of a plotter device U1, in particular, in the image forming apparatuses P1 through P3 illustrated in FIG. 4.

FIG. 6 is a drawing for explaining an example of a paper sheet transferring method in the printing process of the image forming apparatuses P1 through P3 of FIG. 1.

FIG. 7 is a flowchart illustrating an example of a series of printing processes including a determination process of the final paper sheet of the paper sheet bundle, when a CPU 102 causes the sheet post-processing device to perform the post-processing, through an image quality maintaining/adjusting process.

### DESCRIPTION OF EMBODIMENTS

In the following, embodiments will be described in detail by referring to the accompanying drawings.

In the embodiments described hereinafter, at the timing when post-processing and an image quality maintaining/adjusting process in a series of an printing processes are performed, a time required for the post-processing of a paper sheet bundle (also referred to as “bundle”, hereinafter) by a post-processing device is calculated on a post-processing basis, a paper sheet spacing (i.e., a spacing between the final paper sheet of the paper sheet bundle to be post-processed and a next paper sheet) is increased for the post-processing, and the image quality maintaining/adjusting process is performed in synchronization with the increased paper sheet spacing (a time of increasing the paper sheet spacing). In other words, during the printing processes using the post-processing device, the image quality maintaining/adjusting process of the printing part is performed in a synchronized manner utilizing the time required for the post-processing, such as stapling, punching, bookbinding, etc., thereby shortening the time required for the printing processes including the post-processing by the post-processing device and thus improving the productivity of the printing.

Hereinafter, concrete embodiments are described in detail.

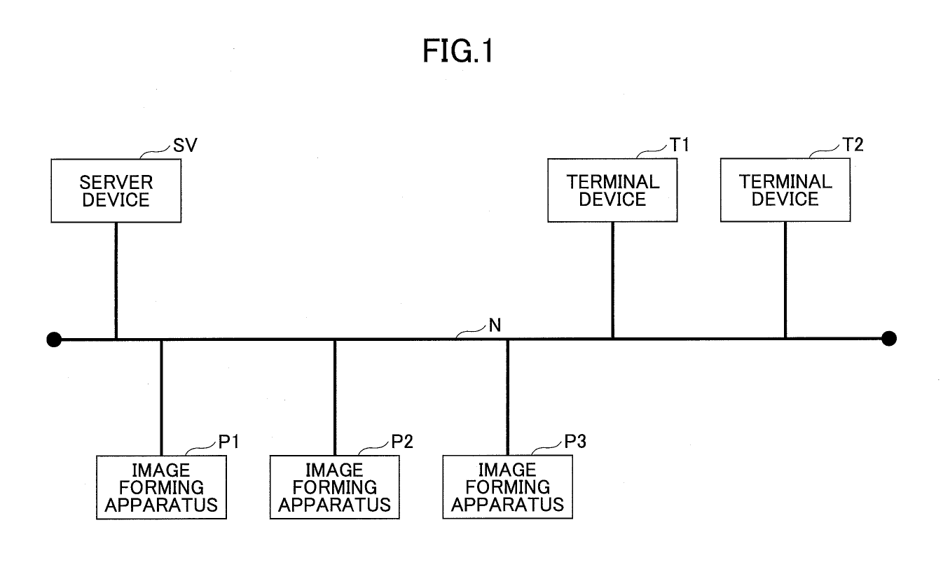

FIG. 1 is a drawing conceptually illustrating an example of a schematic network configuration of an image forming system including an image forming apparatus with a post-processing device according to an embodiment.

In the image forming system, as illustrated in FIG. 1, for example, terminal devices T1 and T2, which send print (image-forming) jobs based on instructions from an operator, and image forming apparatuses P1 through P3, which perform printing operations for printing image information on paper sheets (any type of sheets are applicable) based on the print jobs, are coupled via a network N, such as LAN (Local Area Network), etc. A server device SV is also coupled to the network N. The server device SV is configured to manage statuses of consumable items and residues of the respective image forming apparatuses P1 through P3 and allocate the print jobs to the respective image forming apparatuses P1 through P3.

The terminal devices T1 and T2 are information processing device such as PCs (personal computers), work stations, etc.

The image forming apparatuses P1 through P3 have an image printing function based on the print jobs from the terminal devices T1 and T2 and a post-processing function. For example, the image forming apparatuses P1 through P3 are not limited to image forming apparatuses which have only the print function, such as laser printers, ink jet printers or the like. The image forming apparatuses P1 through P3 may be digital copy devices or digital multiple function printers which have other functions such as a copy function in addition to the print function.

When a print instruction (i.e., the print job) is transmitted from the terminal devices T1 and T2 via the network N, the server device SV receives it to select, based on print job information and the statuses of consumable items and residues of the respective image forming apparatuses P1 through P3, the image forming apparatus which is to perform the printing processes.

It is noted that the illustrated network N is of bus-type; however, the network N is not limited to this type and may be of star-type or ring-type.

Further, the consumable items managed by the server device SV include items which need to be refilled or exchanged on a regular basis, such as paper sheets used for printing images according to the print jobs, toner or ink for printing images, staples for stapling, adhesives for bookbinding without strings, tapes for tape bookbinding, rings for ring bookbinding, binding strips for sure bookbinding, etc.

Further, the residues managed by the server device SV includes items to be removed on a regular basis, such as scrap pieces generated by the punching process, cuttings generated by sheet cuttings, scrap pieces of the staples generated by the stapling process, etc.

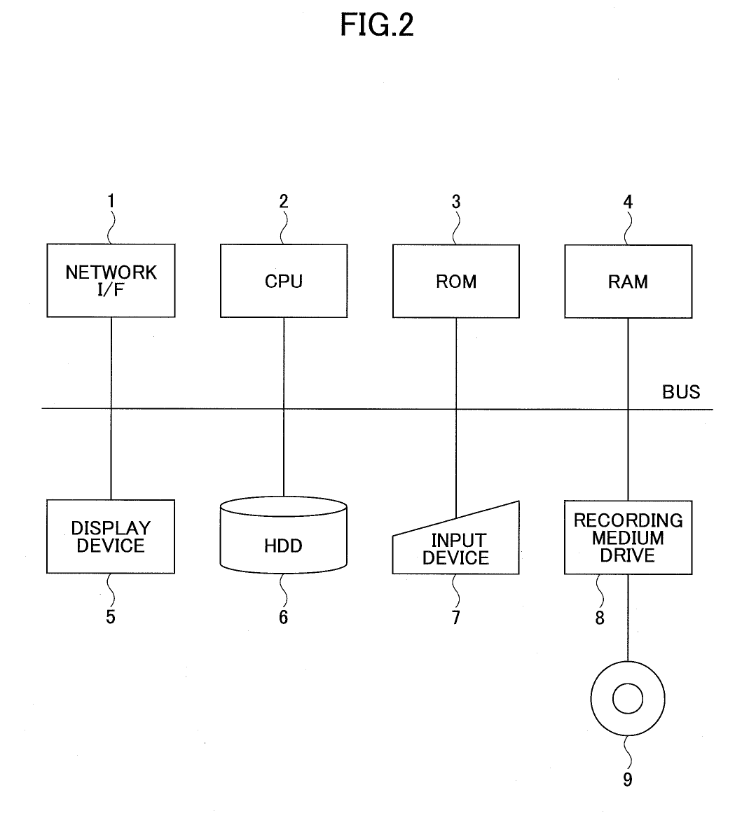

FIG. 2 is a drawing illustrating an example of a hardware configuration of the server device SV in FIG. 1.

The server device SV includes a network I/F (interface) 1, a CPU 2, a ROM 3, a RAM 4, a display device 5, a HDD (hard disk drive) 6, an input device 7 and a recording medium drive 8.

The network I/F 1 is used for communicating with the terminal devices T1 and T2 and the image forming apparatuses P1 through P3 via the network N.

The CPU 2 manages and controls the server device SV as a whole.

The ROM 3 stores fixed data or fixed programs executed by the CPU 2.

The RAM 4 is a readable and writable memory which is used as a work area when the CPU 2 executes the programs to perform processes.

The display device 5 displays various items of data, work screen (operation screen), etc. The display device 5 is a CRT display, LCD, etc.

The HDD 6 has a large capacity and stores various items of data and programs including an OS (Operating System) and application programs.

The input device 7 is used by a user when the user inputs various items of operational information. Keyboards and pointing devices such as a mouse can be used as the input device 7.

The recording medium drive 8 performs recording and reproducing of the recording medium 9.

The recording medium 9 is detachable with respect to the recording medium drive 8 and stores a program (software) for executing management of the print jobs. The recording medium 9 may be MO, CR-R, CD-RW, DVD-RAM, etc.

According to the sever device SV, the CPU can read a necessary program from the recording medium 9 via the recording medium drive 8 and install it in the HDD 6. Further, the program may be downloaded from an external device (not illustrated) via the network N.

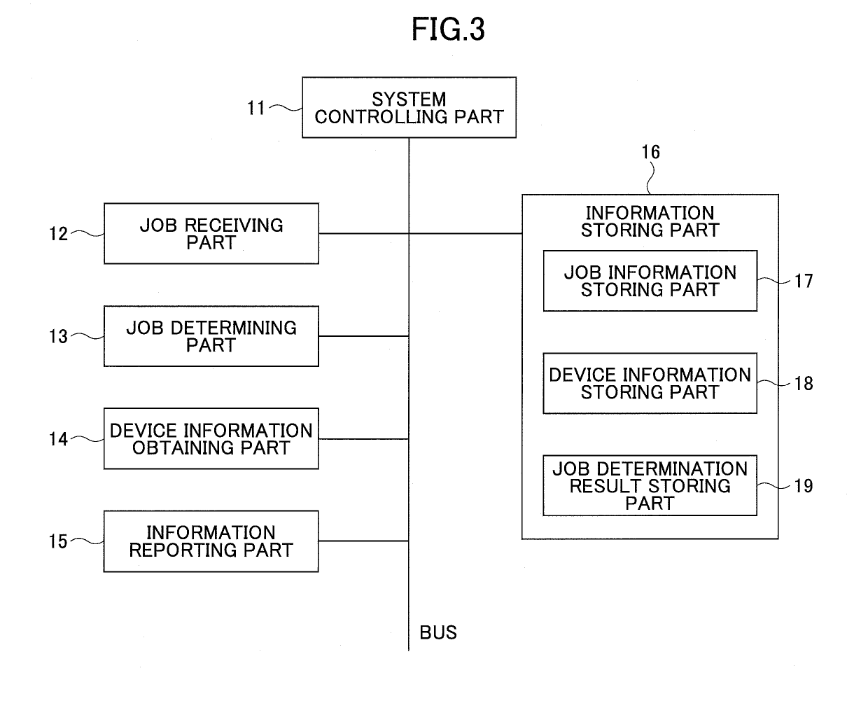

FIG. 3 is a drawing illustrating an example of functions of the server device SV illustrated in FIG. 2.

The server device SV includes a system controlling part 11, a job receiving part 12, a job determining part 13, a device information obtaining part 14, an information reporting part 15, and an information storing part 16.

The information storing part 16 includes a job information storing part 17, a device information storing part 18 and a job determination result storing part 19. These functional blocks are implemented by the hardware illustrated in FIG. 2 and the programs not illustrated.

The system controlling part 11 controls the respective parts to perform the information management of the image forming apparatuses P1 through P3 and the determination of the jobs.

The job receiving part 12 receives the print jobs transmitted from the terminal devices T1 and T2 via the network N. The information of the print job received by the job receiving part 12 is temporarily stored in the job information storing part 17. The information of the print job includes information about an output size or the number of copies, parameters related to the finishing process (post-processing) such as stapling, punching, etc., and the terminal device which transmits the print job.

The device information obtaining part 14 obtains information about the consumable items and residues from the image forming apparatuses P1 through P3 which is managed by the server device SV. The process for obtaining the information is performed whenever there is a change in statuses of the consumable items and residue in the image forming apparatuses P1 through P3. The obtained information is stored in the device information storing part 18.

The job determining part 13 analyzes the information of the print job stored in the job information storing part 17, and refers to the parameters related to the printing included in the information and the information about the consumable items and residue in the image forming apparatuses P1 through P3 stored in the device information storing part 18 to determine which of the image forming apparatuses P1 through P3 can perform the print job. The determination result is stored in the job determination result storing part 19.

The information reporting part 15 reports the determination result (i.e., the information representing which of the image forming apparatuses P1 through P3 can perform the print job) stored in the job determination result storing part 19 to the terminal device which transmitted the print job. Further, once the image forming apparatus P1, P2 or P3 to be used for printing (i.e., performing the print job) is selected, the information reporting part 15 reports the information of the print job stored in the job information storing part 17 to the selected image forming apparatus P1, P2 or P3 to cause the selected image forming apparatus P1, P2 or P3 to perform the print job. Further, the information reporting part 15 reports the information of the selected image forming apparatus P1, P2 or P3 to the terminal device which transmitted the print job.

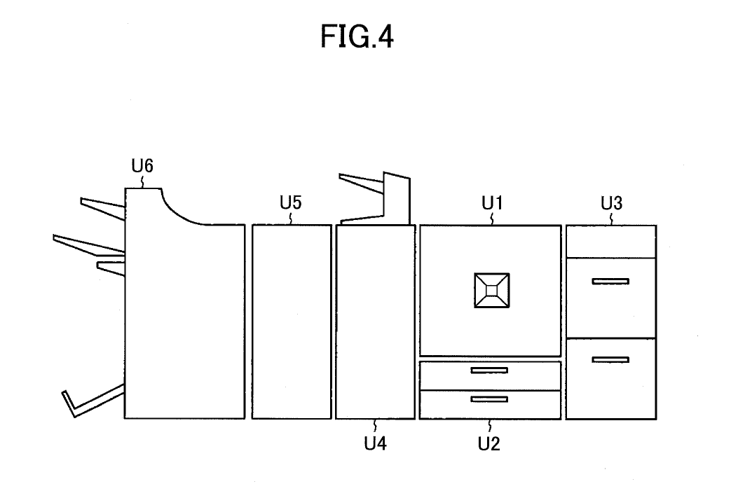

FIG. 4 is a plane view of an example of an overall configuration of each of the image forming apparatuses P1 through P3 of FIG. 1.

The image forming apparatuses P1 through P3, as illustrated in FIG. 4, for example, include plotter devices U1, sheet storage devices U2 and U3, peripherals (peripheral units) of sheet post-processing devices U4 through U6.

The plotter device U1 is an image forming part which forms a body of an electrophotographic or inkjet image forming apparatus, for example. The plotter device U1 generates image information (i.e., image data) based on the print jobs from the terminal devices T1 and T2 illustrated in FIG. 1, performs a printing operation for printing the image information as a visible image on a sheet (a paper sheet in this example), and transfers the printed sheet to the sheet post-processing devices U4.

The sheet storage devices U2 and U3 stores paper sheets used for printing of images. The sheet storage device U2 is coupled to the lower side of the plotter device U1 and has a relatively small capacity. The sheet storage device U3 is arranged side by side with respect to the plotter device U1 and has a relatively great capacity. These sheet storage devices U2 and U3 include plural paper feeding trays in which the paper sheet bundles with different sizes are stored (the paper sheet bundle of each size is stored in one of the paper feeding trays). Each sheet storage device can feed (supply) the paper sheets to the plotter device U1.

The sheet post-processing devices U4 through U6 are configured to perform different post-processing on the paper sheets ejected from the plotter device U1. Plural sheet post-processing devices may be coupled. The sheet post-processing device U4 is an inserting device for inserting a cover or an inserting paper for bookbinding, for example. The sheet post-processing device U5 is a punching device for performing the punching process or a folding device for folding the paper sheets for bookbinding, for example. The sheet post-processing device U6 is a staple device for performing the stapling process on the paper sheets, a bookbinding device for bookbinding with tapes or rings or sure bookbinding, or a cutting device for cutting the book-bound paper sheets into the final size, for example.

Further, the image forming apparatuses P1 through P3 include consumable item storage units (not illustrated) for storing the consumable items such as staples for stapling, adhesives for bookbinding without strings, tapes for tape bookbinding, rings for ring bookbinding, binding strips for sure bookbinding, etc. According to the staple processing, the scrap pieces of the staples are generated when the staples are cut according to the number of printed sheets to be book-bound. According to the punching process, the punching scrap pieces are generated when holes are made in the print paper sheets. According to the bookbinding process, the cuttings (scrap pieces) are generated when the three-sided finishing trimming and the milling process for bookbinding without strings are performed. The image forming apparatuses P1 through P3 include residue collecting units for storing residue such as scrap pieces of the staples, punching scrap pieces and cuttings.

It is noted that in order to implement the function as a single image forming apparatus, the image forming apparatuses P1 through P3 may include automatic document feeding devices, image reading devices, operation parts (operation panels).

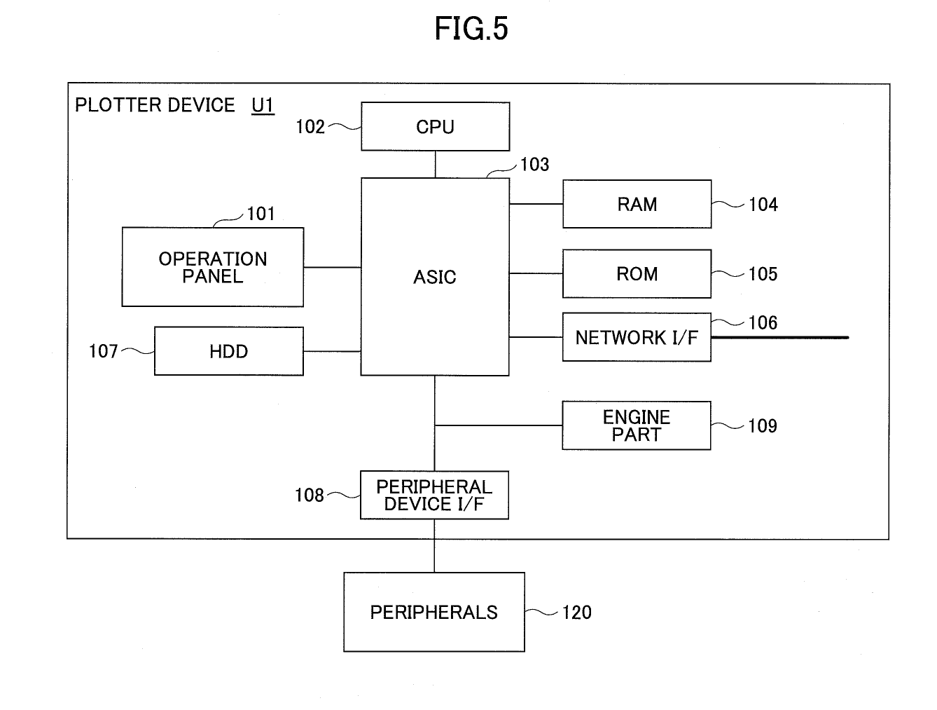

FIG. 5 is a block diagram illustrating an example of a configuration of a control system of plotter device U1, in particular, in the image forming apparatuses P1 through P3 illustrated in FIG. 4.

The plotter device U1 includes an operations panel (operation part) 101, a CPU 102, an ASIC (Application Specific Integrated Circuit) 103, a RAM 104, a ROM 105, a network I/F 106, a HDD 107, a peripheral device I/F 108 and an engine part 109.

The operations panel 101 includes various operation keys for inputting operational demands (instructions) for the engine part 109 and the peripherals 120 according to the user operations, and a display part. As the operation keys, a hardware key such as a ten key, a start key, function keys, one-touch keys, etc., or a touch panel can be used in order to input the instructions for the engine part 109 and the peripherals 120. As the display part, a liquid crystal display can be used, for example, to display operational statuses. In fact, the operations panel 101 is provided outside of the plotter device U1.

Externally provided instructions, that is to say, instructions from the operations panel 101 or the network I/F 106 (i.e., the terminal devices T1 and T2, etc.) enable selecting one of the sheet post-processing devices U4 through U6 to be used for the post-processing, selecting one of an image quality-oriented mode in which a higher priority is given to the quality of the image printed by the engine part 109 and a speed-oriented mode in which a higher priority is given to the speed (throughput of printing) of a series of printing processes including the post-processing for the printed sheet or the sheet bundle, such as stapling, punching, bookbinding, etc., and selecting one of the paper feeding trays in the sheet storage devices U2 and U3 illustrated in FIG. 4 to be used to feed the paper sheets for the series of printing processes. It is noted that in the case of there being a sheet re-feeding device, instructions from the operation panel 101 or the network I/F 106 enable selecting one of a concentration mode in which images of plural pages are printed on a side of a single paper sheet and a duplex mode in which images of two pages are printed one on each side of a single paper. Further, in the case of there being an image reading part, instructions from the operations panel 101 enable setting a copy mode.

The CPU 102 manages and controls the plotter device Ul as a whole.

The ASIC 103 is a multi function device board including plural I/Fs for coupling the CPU 102, the RAM 104, the ROM 105, the network I/F 106, the peripheral device I/F 108, the engine part 109 and the operations panel 101. The ASIC 103 is an IC for promoting sharing of devices to be controlled by the CPU 10 and supporting high-efficiency of development of the applications, etc., in term of architectures. The ASIC 103 includes hardware resources for image processing, for example.

The RAM 104 is a readable and writable memory which is used as a work area when the CPU 2 executes the programs to perform processes, or is used as an image memory when the CPU 2 processes print data included in the print job received externally into bitmap-like image information (image data) for printing the visible image on the paper sheet by the engine part 109.

The ROM 105 stores fixed data or fixed programs including bootstrap programs executed by the CPU 2.

The network I/F 106 is used for communicating with the terminal devices T1 and T2, which are external devices, and the sever device SV via the network N.

The HDD 107 has a large capacity and stores various items of data including settings and programs including an OS and application programs. It is noted that storages other than the HDD 107, for example, a nonvolatile memory such as a flash ROM, an EEPROM, etc., may be used to store the data, etc.

The peripheral device I/F 108 is provided for communicating with the peripherals 120. The peripherals 120 correspond to the sheet storage devices U2 and U3 and the sheet post-processing devices U4 through U6; however, the peripherals 120 may include an automatic document feeding device configured to automatically feed a document (manuscript) set in a document tray to a reading position where the document is read by the image reading part, and a sheet re-feeding device for re-feeding the paper sheet, which has been printed by the engine part 109 of the plotter device U1, to the engine part 109 directly or after reversing the paper sheet.

The engine part 109 includes a printing part (an image forming part) for printing the image as a visible image on a paper sheet; however, it may additionally include an image reading part (a scanner part, etc.) for reading image information of the document set at the reading position.

If the print job is received from the network I/F 106, the printer mode is set, the image quality-oriented mode or the speed-oriented mode is selected according to the command (instruction) included in the print job, and image information of the respective pages is produced successively based on the print data of the respective pages included in the print job. At that time, the image information is manipulated (changed), as necessary, according to the command included in the received print job. It is noted that if the received print job includes the command for instructing the selection of the concentration mode or the duplex mode, the concentration mode or the duplex mode is selected according to the command.

In each of the image forming apparatuses P1 through P3, when power is turned on, the CPU 102, according to the bootstrap program in the ROM 105 coupled thereto via the ASIC 103, reads programs in the HDD 107 to install them in the RAM 104, then controls the input/outputs with respect to the devices coupled thereto via the ASIC 103, and controls communications between the peripherals 120 and the engine part 109 or the peripheral I/F 108 to control the series of the printing processes including the process with the engine part 109 (printing by the printing part, for example) and processes with peripherals 120 (post-processing with the sheet post-processing devices U4 through U6).

If the concentration mode is selected in the case of there being the sheet re-feeding device, the paper sheet whose one side has an image printed by the engine part 109 is re-fed to the engine part 109 directly by the sheet re-feeding device, and then another image can be printed on the same side of the paper sheet. Further, if the duplex mode is selected, the paper sheet whose one side has an image printed by the engine part 109 is reversed and re-fed to the engine part 109 by the sheet re-feeding device, and then another image can be printed on another side of the paper sheet.

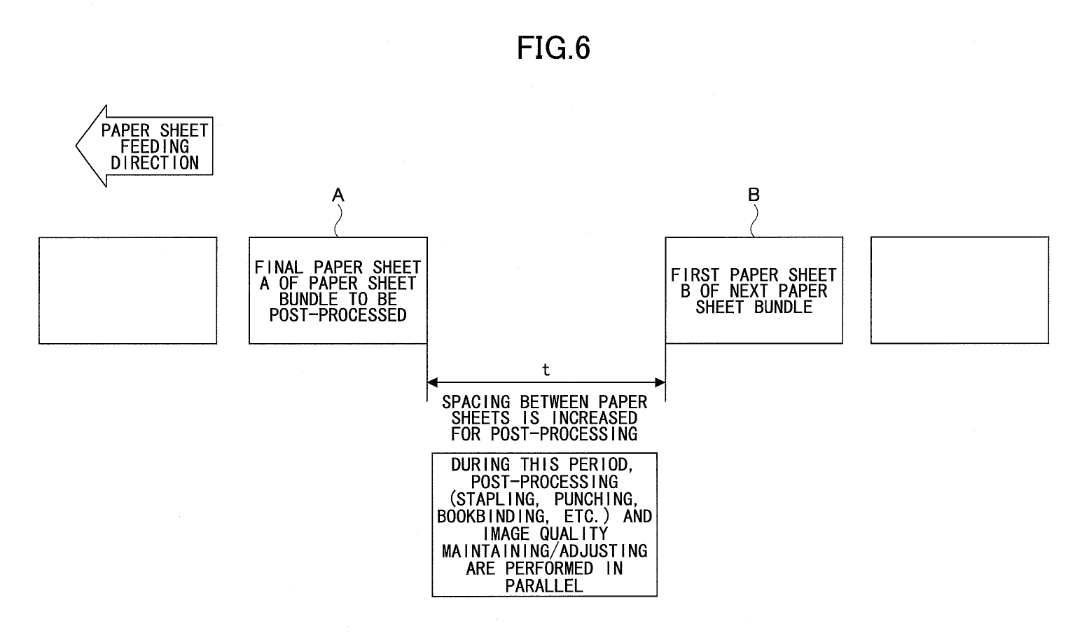

FIG. 6 is a drawing for explaining an example of a paper sheet transferring method in the printing process of the image forming apparatuses P1 through P3 of FIG. 1.

In each of the image forming apparatuses P1 through P3, when the post-processing, such as stapling, punching, bookbinding, etc., is to be performed, for example, during the printing processes using the sheet post-processing devices U4 through U6, the spacing between the final paper sheet A of the paper sheet bundle to be post-processed and a first paper sheet B of the next paper sheet bundle is increased according to the time t required for the post-processing, the time t for increasing the spacing between the final paper sheet A and the first paper sheet B is calculated, and during the time period of the time t after the completion of the printing of the final paper sheet A, the post-processing of the paper sheet bundle and the image quality maintaining/adjusting process are performed in parallel. It is noted that the spacing is the product of the time t and a copy speed (linear speed).

The image quality maintaining/adjusting process is performed in order to maintain the quality of the image to be printed on the paper sheet. In the case where the plotter device U1 is of an electrophotographic type, for example, the image quality maintaining/adjusting process includes the adjustment of the concentration of the image formed on a photosensitive element (image carrier), the adjustment of the intensity of the exposure to the photosensitive element, the adjustment of the voltage applied to a transferring part for transferring the image on the photosensitive element to the paper sheet, etc., which are performed based on measurement of the concentration from the concentration sensor (not illustrated), measurement of the potential from the potential sensor (not illustrated), etc.

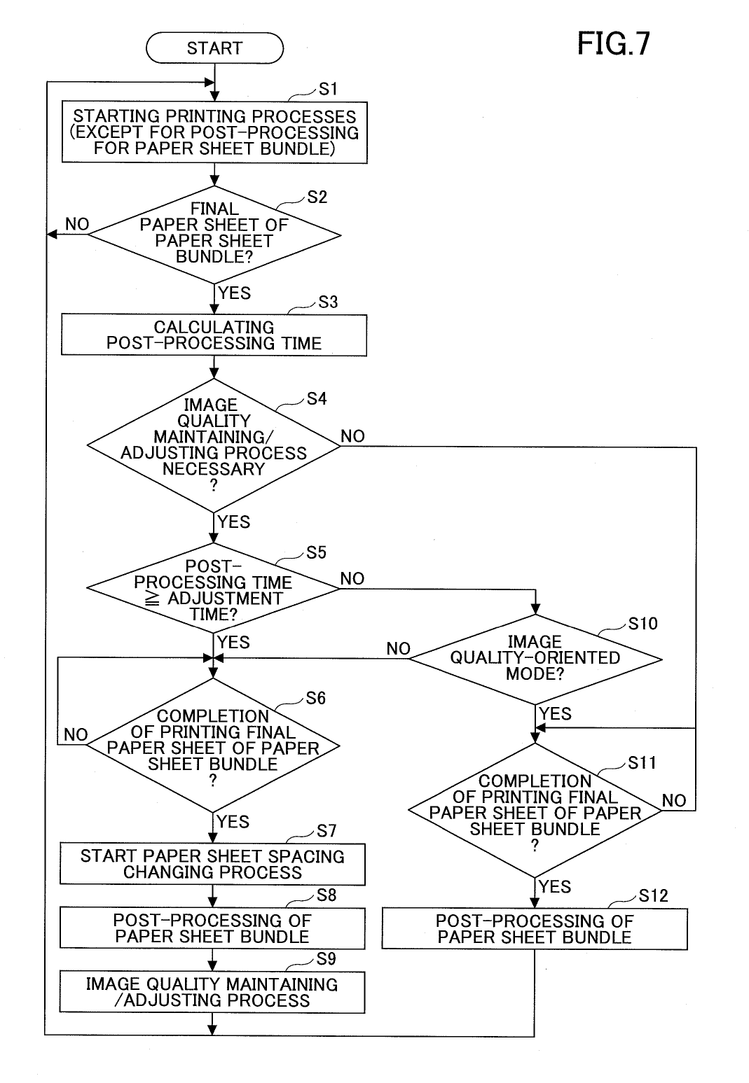

FIG. 7 is a flowchart illustrating an example of a series of printing processes including a determination process of the final paper sheet of the paper sheet bundle, when a CPU 102 causes the sheet post-processing device to perform the post-processing, through an image quality maintaining/adjusting process. It is noted that in this example the printing processes for plural copies are performed based on the received print job including the print data of plural pages from the network I/F 106; however, in the case of there being the automatic document feeding device and the image reading device, the automatic document feeding device and the image reading device may read the image information of the document of plural pages successively to perform the printing processes for plural copies.

The CPU 102 receives the print job from the network I/F 106, and then according to the commands included in the print job, performs the setting of the number of copies, the selection between the image quality-oriented mode and the speed-oriented mode, the selection of one(s) of the sheet post-processing devices U4 through U6 to be used for the post-processing, and the selection of one of the paper feeding trays of the sheet storage devices U2 and U3 in FIG. 4 to be used for feeding the paper sheets used for a series of the printing processes, and then goes to step 1 to start the series of the printing processes including the post-processing. In step 1, the CPU 102 starts the printing by the engine part 109 based on the received print job.

Specifically, the image information of the respective pages is produced successively based on the print data of the respective pages included in the received print job, the image information is successively sent to the engine part 109, and the printing is successively performed on the paper sheets which are fed successively from the paper feeding tray selected by the command included in the received print job. Further, the printed paper sheets are subject to the post-processing (except for the post-processing for the paper sheet bundle) by the sheet post-processing device selected by the command included in the received print job, and then are ejected out of the machine. The series of the printing processes are performed according to the number of pages of the print data. It is noted that if only the post-processing for the paper sheet bundle (stapling, punching, bookbinding, etc.) is required, the post-processing is not performed in step 1.

The CPU 102 goes to step 2 after starting the process of step 1 to determine whether the printing is performed on the last paper sheet of the paper sheet bundle (in this example, the paper sheet bundle including the number of the sheets required for the printing of one copy of the pages of the print data). If the last paper sheet of the paper sheet bundle is not printed yet, the CPU 102 returns to step 1 to repeat the processes described above. If the last paper sheet of the paper sheet bundle is printed, the CPU 102 goes to step 3 to calculate the time t (referred to as “the post-processing time”, hereinafter) required for the post-processing of the paper sheet bundle to be post-processed by the selected sheet post-processing device.

The post-processing time t may be calculated (determined) according to a type of the post-processing, the paper sheet size of the paper sheet bundle, etc. For example, the post-processing times associated with the respective types of the post-processing may be stored in advance in the memory (the ROM 105 or the HDD 107). With this arrangement, if the paper sheet size is fixed, the post-processing time can be determined based on the type of the post-processing performed by the selected sheet post-processing device. Further, if the post-processing times associated with the respective types of the post-processing and paper sheet sizes may be stored in advance in the memory. With this arrangement, the post-processing time can be determined based on the type of the post-processing performed by the selected sheet post-processing device and the paper sheet size of the sheets fed from the selected paper feeding tray.

The CPU 102 goes to step 4 after performing the process of step 3. In step 4, the CPU 102 determines whether the image quality maintaining/adjusting process is necessary to maintain the quality of the image printed by the engine part 109. The determination may be performed based on the input values of the number of the copied paper sheets, the potential required to print the image (an electrostatic latent image on the photosensitive element, for example), etc. For example, if the number of the copied paper sheets reaches a predetermined value (1000, for example) or the value of the potential required to print the image reaches a predetermined value, the CPU 102 determines that the image quality maintaining/adjusting process is necessary. It is noted that the number of the copied paper sheets may be input as necessary if the RAM 104 illustrated in FIG. 5, for example, is used as a number counter whose value is incremented by 1 at each time of printing. Further, the value of the potential may be measured by the corresponding sensor as necessary.

The CPU 102 goes to step 11 if it determines that the image quality maintaining/adjusting process is not necessary in step 4, while it goes to step 5 if it determines that the image quality maintaining/adjusting process is necessary in step 4. In step 5, the CPU 102 compares the calculated post-processing time with the time (adjustment time) required for the quality maintaining/adjusting process, which is stored in advance in the memory (the ROM 105 or the HDD 107). If the post-processing time is greater than or equal to the adjustment time, the CPU 102 permits the quality maintaining/adjusting process and goes to step 6.

The CPU 102 goes to step 7 after the completion of printing the final paper sheet of the paper sheet bundle to be post-processed. In step 7, the CPU 102 starts a process (paper sheet spacing changing process) for increasing the spacing between the final paper sheet of the paper sheet bundle to be post-processed and the first paper sheet of the next paper sheet bundle according to the post-processing time and performs the processes of steps and 9 in parallel. It is noted that the paper sheet spacing changing process includes delaying the transfer of the first paper sheet of the next paper sheet bundle.

In step 8, the CPU 102 performs the post-processing for the paper sheet bundle with the sheet post-processing device selected by the command included in the received print job.

In step 9, the CPU 102 performs the image quality maintaining/adjusting process.

The CPU 102 returns to step 1 after completion of the processes of steps 8 and 9, and repeats the processes described above.

On the other hand, if the CPU 102 determines that the post-processing time is less than the adjustment time in step 5, the CPU 102 goes to step 10 to determine whether the image quality-oriented mode is selected. If the mage quality-oriented mode is selected, the CPU 102 permits the image quality maintaining/adjusting process and goes to step 6 to perform the processes described above. If the speed oriented mode is selected instead of the mage quality-oriented mode, the CPU 102 does not permit the image quality maintaining/adjusting process (i.e., prevents the image quality maintaining/adjusting process). Specifically, the CPU 102 waits for the completion of the printing of the image on the final paper sheet of the paper sheet bundle to be post-processed in step 11, and then goes to step 12′ to perform the post-processing on the paper sheet bundle as is the case with step 8. Then, the CPU 102 returns to step 1.

It is noted that the first paper sheet of the next paper sheet bundle is fed after the final paper sheet of the paper sheet bundle to be post-processed has been fed from the selected paper feeding tray. At that time, if the size of the next paper sheet bundle is different and thus the paper feeding tray is switched to the other paper feeding tray for feeding the first paper sheet of the next paper sheet bundle, this switching causes a delay in the printing processes. The delay may be detected by the CPU 102. Further, if the greater number of the paper sheets (the paper sheet bundle) are fed from the same paper feeding tray, the transport of the paper sheet bundle within the paper feeding tray may become necessary. This transport causes a delay in the printing processes. The delay may be detected by the CPU 102. Further, if the image information is manipulated, such a manipulation causes a delay in the printing processes. The delay may be detected by the CPU 102. Further, in the case of there being the sheet re-feeding device, if the concentration mode or the duplex mode is selected, the re-feeding of the paper sheets from the sheet re-feeding device causes a delay in the printing processes. The delay may be detected by the CPU 102. Thus, if such a delay is detected, it is possible to perform the image quality maintaining/adjusting process in synchronization with the detection of the delay. In other words, it is possible to perform the image quality maintaining/adjusting process utilizing such a delay time.

In this way, in order to process the paper sheet bundle of the paper sheets printed by the plotter device, the image forming apparatus including the sheet post-processing devices increases the spacing between the final paper sheet of the paper sheet bundle and the first paper sheet of the next paper sheet bundle. At that time, the image forming apparatus performs the image quality maintaining/adjusting process in synchronization with increasing the spacing, thereby reducing the total time required to complete a series of the printing processes and thus shortening the total operation time of the image forming apparatus. Therefore, even if the post-processing and the image quality maintaining/adjusting are performed, it is possible to avoid the decrease in the productivity of the printing as much as possible.

Further, if the delay caused by the switching between the paper feeding trays according to the selection, the transport of the sheet bundle in the same paper feeding tray, the manipulation of the image information and the re-feeding of the paper sheet(s) by the sheet re-feeding device is detected and the image quality maintaining/adjusting process is performed in synchronization with the detection of the delay, it is possible to avoid the decrease in the productivity of the printing while preferably keeping the quality of the printed image.

Further, since the image quality maintaining/adjusting is permitted if it is determined that the time required for the post-processing of the paper sheet bundle is greater than or equal to the time required for image quality maintaining/adjusting process, it is possible to more preferably keep the quality of the printed image.

Further, even in the case where the time required for the post-processing of the paper sheet bundle is less than the time required for the image quality maintaining/adjusting process, the image quality maintaining/adjusting process may be permitted if the image quality-oriented mode is selected while the image quality maintaining/adjusting process may not be permitted if the speed-oriented mode is selected. In this case, it is possible to perform the operations based on the demands of the user, thereby improving the ease-of-use.

It is noted the computer (CPU) for controlling the image forming apparatus executes the programs to implement various functions described above.

Such programs may be stored in advance in the memory included in the image forming apparatus such as the ROM or a nonvolatile memory (a flash ROM, an EEPROM, etc.), or HDD; however, the program may be recorded on a recording medium, such as a CD-ROM or a nonvolatile recording medium, such as a memory card, a flexible disk, a MO, a CD-R, a CD-RW, a DVD+R, a DVD+RW, a DVD-R, a DVD-RW, a DVD-RAM, etc. The program recorded in such a recording medium is installed in a computer for execution by the CPU, or the CPU is instructed to read the program from the recording medium for execution, thereby performing each of the steps as described above.

It is also possible to execute the program by downloading the program from an external apparatus having a recording medium with the program recorded therein or from an external apparatus having the program recorded in the memory medium thereof.

According to the embodiment described above, if the post-processing and the image quality maintaining/adjusting are performed, it is possible to avoid the decrease in the productivity of the printing as much as possible. Therefore, the image forming apparatus can be obtained which can provide the increased quality of the image as well as the increased productivity of the printing.

The present application is based on Japanese Priority Application No. 2010-207963, filed on Sep. 16, 2010, the entire contents of which are hereby incorporated by reference.

What is claimed is:

1. An image forming apparatus comprising:
an image forming part configured to form an image on a sheet;
a post-processing part configured to process a sheet bundle, the sheet bundle including sheets on which images are formed by the image forming part;
an image quality maintaining/adjusting part configured to maintain quality of the image formed by the image forming part;
a sheet spacing changing part configured to increase a spacing between a final sheet of the sheet bundle and a next sheet; and
an operation controlling part configured to activate an operation of the image quality maintaining/adjusting part such that the operation of the image quality maintaining/adjusting part is completed within the spacing increased by the sheet spacing changing part.

2. The image forming apparatus as claimed in claim 1, wherein the sheet spacing changing part increases the spacing between the final sheet of the sheet bundle and the next sheet such that the increased spacing corresponds to a time required for the processing of the sheet bundle by the post-processing part.

3. The image forming apparatus as claimed in claim 2, wherein the sheet spacing changing part calculates, based on a type of the processing, the time required for the processing of the sheet bundle by the post-processing part.

4. The image forming apparatus as claimed in claim 2, wherein the sheet spacing changing part calculates, based on a size of the sheet bundle, the time required for the processing of the sheet bundle by the post-processing part.

5. The image forming apparatus as claimed in claim 2, further comprising:
plural sheet feeding parts configured to feed the sheets to the image forming part;
a selecting part configured to select, according to an externally provided instruction, one of the sheet feeding parts which feeds the sheets for a series of image forming processes to be performed by the image forming part and the post-processing part; and
a delay detecting part configured to detect a delay time in the image forming processes, the delay time being caused by a switching of the sheet feeding parts according to the selection by the selecting part or a transport of the sheet bundle within the sheet feeding part,
wherein the operation controlling part activates the operation of the image quality maintaining/adjusting part such that the operation of the image quality maintaining/adjusting part is completed within the delay time detected by the delay detecting part and the spacing increased by the sheet spacing changing part.

6. The image forming apparatus as claimed in claim 5, further comprising:
a sheet re-feeding part configured to re-feed the sheet on which the image is formed by the image forming part directly or after reversing the sheet, wherein
the delay detecting part further detects the delay time in the image forming processes caused by the sheet re-feeding of the sheet re-feeding part.

7. The image forming apparatus as claimed in claim 2, wherein
the image forming part is configured to form the image on the sheet based on image information,
the image forming apparatus further comprising:
a manipulating part configured to manipulate the image information according to an externally provided instruction; and
a delay detecting part configured to detect a delay time in a series of image forming processes performed by the image forming part and the post-processing part, the delay time being caused by the manipulation of the image information by the manipulating part, wherein
the operation controlling part activates the operation of the image quality maintaining/adjusting part such that the operation of the image quality maintaining/adjusting part is completed within the delay time detected by the delay detecting part and the spacing increased by the sheet spacing changing part.

8. The image forming apparatus as claimed in claim 2, further comprising:
a time determining part configured to determine whether the time required for the processing of the sheet bundle by the post-processing part is greater than or equal to a time required for the maintaining of the quality of the image by the image quality maintaining/adjusting part; and
an operation permitting part configured to permit the operation controlling part to activate the operation of the image quality maintaining/adjusting part if it is determined by the time determining part that the time required for the processing of the sheet bundle by the post-processing part is greater than or equal to a time required for the maintaining of the quality of the image by the image quality maintaining/adjusting part.

9. The image forming apparatus as claimed in claim 8, further comprising:
a mode selecting part configured to select, according to an externally provided instruction, an image quality-oriented mode in which a higher priority is given to the quality of the image formed by the image forming part or a speed-oriented mode in which a higher priority is given to a speed of the series of image forming processes performed by the image forming part and the post-processing part, wherein
if it is determined by the time determining part that the time required for the processing of the sheet bundle by the post-processing part is smaller than the time required for the maintaining of the quality of the image by the image quality maintaining/adjusting part, the operation permitting part permits the operation controlling part to activate the operation of the image quality maintaining/adjusting part when the image quality-oriented mode is selected by the mode selecting part, while the operation permitting part does not permit the operation controlling part to activate the operation of the image quality maintaining/adjusting part when the speed-oriented mode is selected by the mode selecting part.

10. A control method in an image forming apparatus, the image forming apparatus including: an image forming part configured to form an image on a sheet; a post-processing part configured to process a sheet bundle, the sheet bundle including sheets on which images are formed by the image forming part; and an image quality maintaining/adjusting part configured to maintain quality of the image formed by the image forming part, the control method comprising:
increasing a spacing between a final sheet of the sheet bundle and a next sheet; and
activating the operation of the image quality maintaining/adjusting part such that the operation of the image quality maintaining/adjusting part is completed within the increased spacing.

11. A computer-readable recording medium on which a program to be executed by a computer is stored to control an image forming apparatus, the image forming apparatus including an image forming part configured to form an image on a sheet; a post-processing part configured to process a sheet bundle, the sheet bundle including sheets on which images are formed by the image forming part; and an image quality maintaining/adjusting part configured to maintain quality of the image formed by the image forming part,
wherein the program causes the computer to execute a process of:
increasing a spacing between a final sheet of the sheet bundle and a next sheet; and
activating an operation of the image quality maintaining/adjusting part such that the operation of the image quality maintaining/adjusting part is completed within the increased spacing.
